(19) United States
(12) Patent Application Publication
(10) Pub. No.: US 2022/0074642 A1
(43) Pub. Date: Mar. 10, 2022

(54) Refrigerator Moisture Removal System

(71) Applicant: Kyllburg Technologies, LLC, Tempe, AZ (US)

(72) Inventor: William J. Birgen, Tempe, AZ (US)

(73) Assignee: Kyllburg Technologies, LLC, Tempe, AZ (US)

(21) Appl. No.: 17/524,898

(22) Filed: Nov. 12, 2021

Related U.S. Application Data
(63) Continuation-in-part of application No. PCT/US2020/032622, filed on Dec. 17, 2020.
(60) Provisional application No. 62/847,426, filed on May 14, 2019.

(51) Int. Cl. F25D 21/14; B01D 53/26; F25D 17/04; F25D 25/02

(52) U.S. Cl. CPC F25D 21/14; B01D 53/265; F25D 17/042; F25D 2317/061; F25D 2321/146; F25D 2317/04131; F25D 25/025

(57) ABSTRACT

This invention is embodied in a system for removing moisture from the air inside a refrigerated space. The preferred embodiment is configured to work on a typical refrigerator that employs a typical refrigerant system with a compressor and a condenser. The preferred embodiment works by fitting a water jacket to the exterior surface of the refrigerant line. The water jacket is connected by flexible tube to a cold plate inside the refrigerator. Preferably a pump circulates fluid between the water jacket and the cold plate. As a result, the cold plate gets colder than the air inside the refrigerator and induces condensation on the cold plate. The condensation can be directed to flow by gravity down to the refrigerator's drip pan.

### FIELD OF THE INVENTION

This invention relates to removing moisture from the air inside a refrigerated space to keep food dry.

### BACKGROUND

Refrigerators have crisper drawers (18) in an attempt to create a micro climate within the larger refrigerator space. While refrigerators do a respectable job at temperature control they do little to remove moisture from the greater refrigerator interior or in specific crispers (18) compartments.

What is needed is a system to keep air inside a refrigerator dry so food stays crisp.

### SUMMARY OF INVENTION

This invention is embodied in a system for removing moisture from the air inside a refrigerator. The preferred embodiment is configured to work on a typical refrigerator that employs a typical refrigerant system with a compressor and a condenser. This invention could work in a residential setting, a commercial setting, or a transportation setting (e.g., truck, train, plane, boat).

The preferred embodiment works by fitting a water jacket to the exterior surface of the refrigerant line. The water jacket is connected by flexible tube to a cold plate inside the refrigerator. Preferably, a pump circulates fluid between the water jacket and the cold plate. As a result, the cold plate gets colder than the air inside the refrigerator and induces condensation onto the cold plate. The condensation flows by gravity down to the refrigerator's drip pan.

### DETAILED DESCRIPTION OF THE DRAWINGS

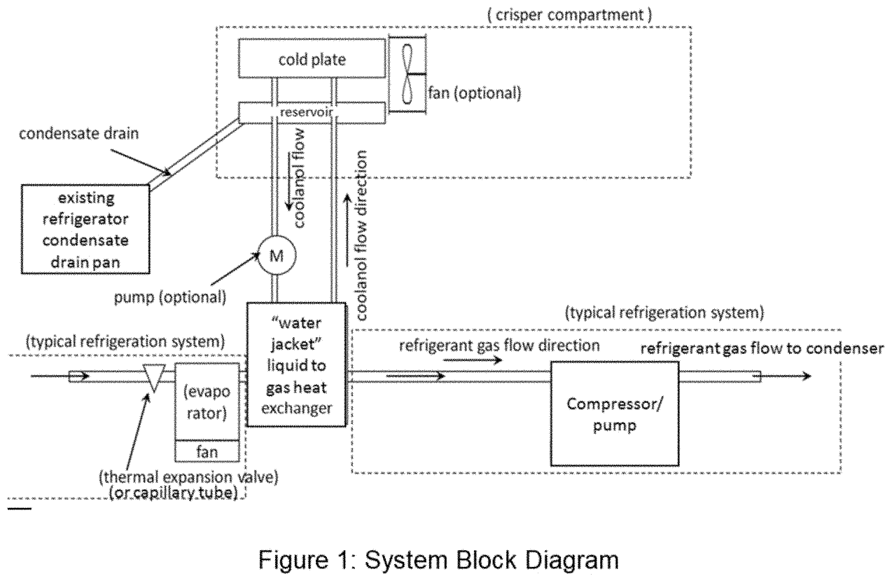

FIG. 1 illustrates a block diagram for the preferred embodiment of the system.

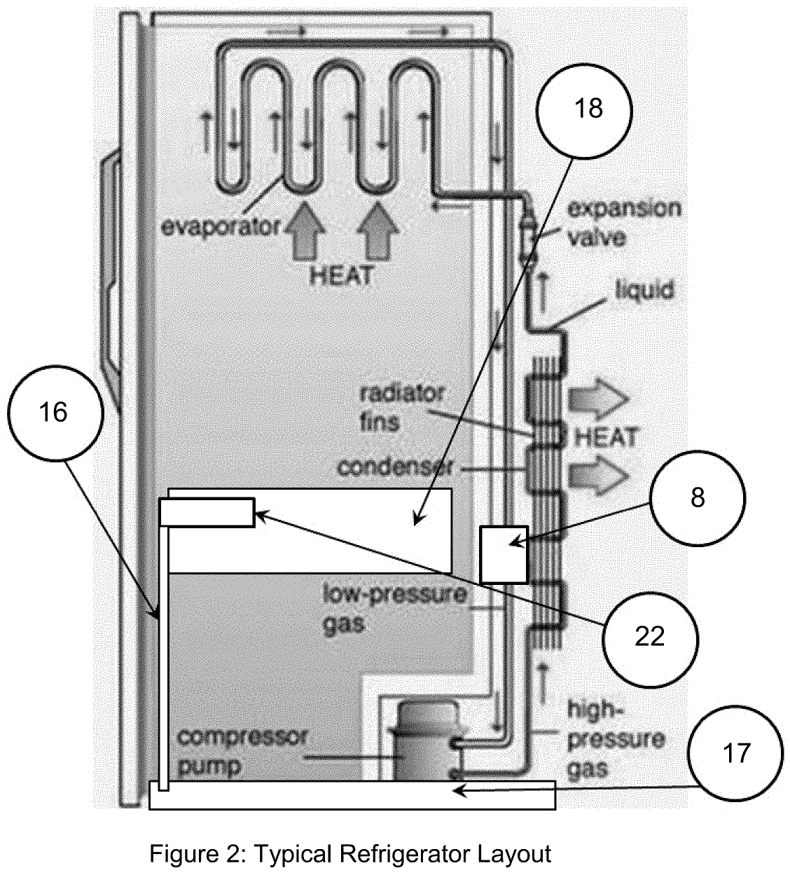

FIG. 2 illustrates a typical refrigerator layout.

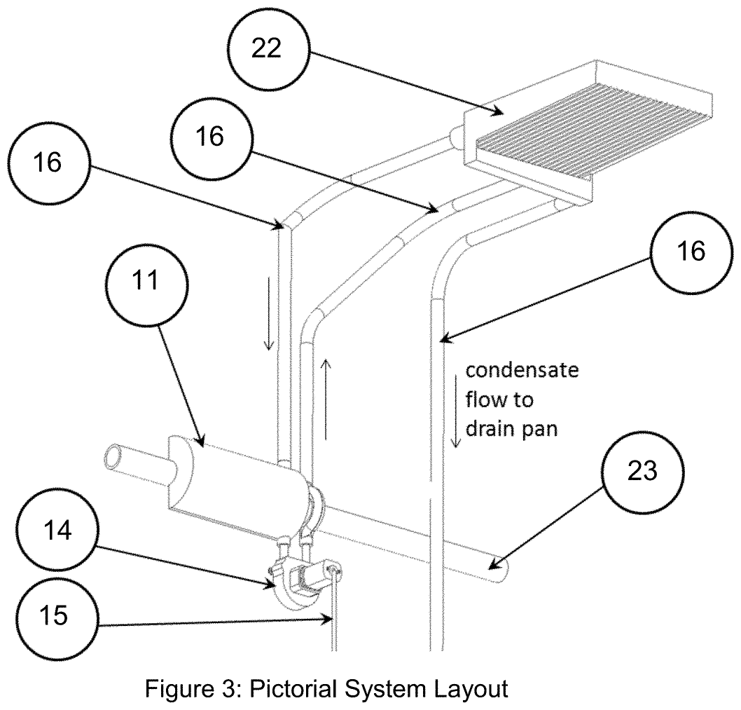

FIG. 3 illustrates a pictorial system layout.

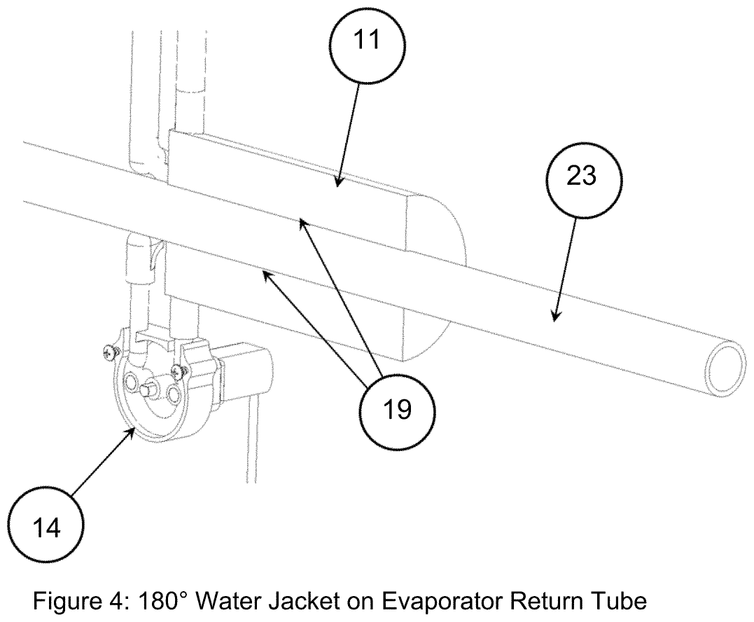

FIG. 4 illustrates a 180° water jacket on evaporator return tube (compressor suction line).

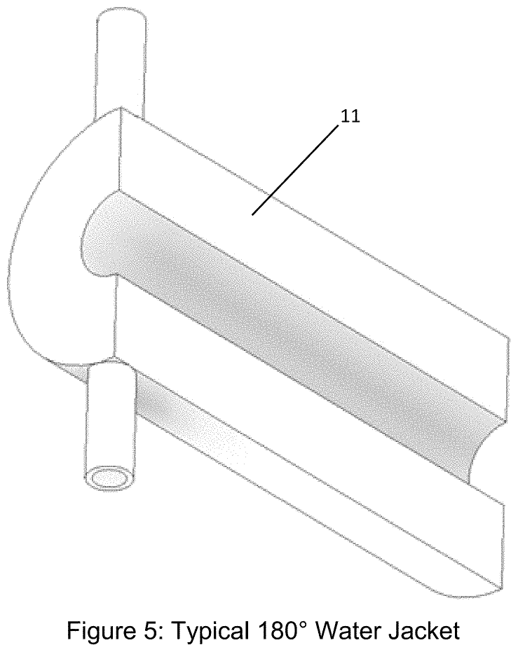

FIG. 5 illustrates a typical 180° water-jacket.

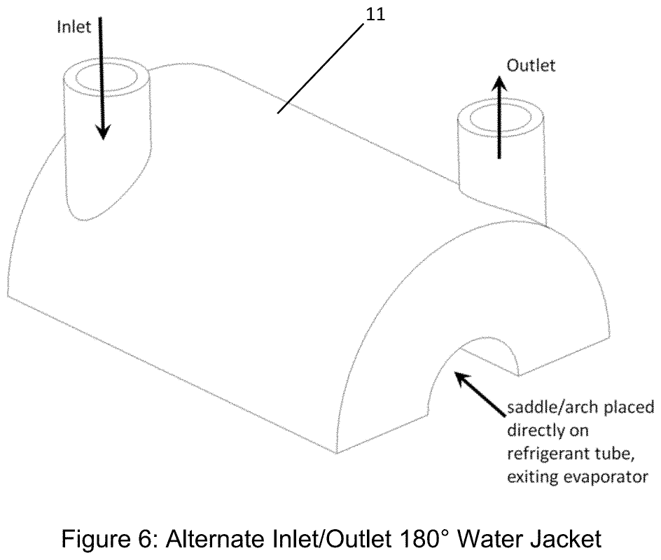

FIG. 6 illustrates an alternate inlet/outlet 180° water jacket. As shown the alternate 180° water jacket is configured to be oriented to fit on top of the refrigerant line. The inlet/outlet are vertically oriented with the interior of the 180° water jacket configured as a saddle to rest directly on the refrigerant tube.

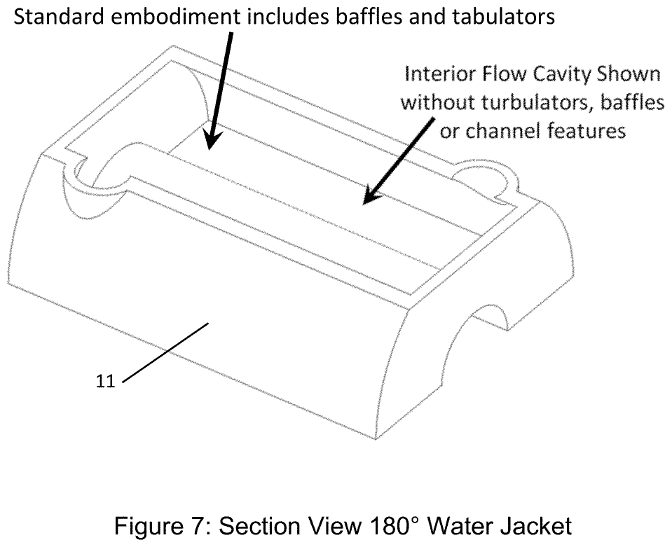

FIG. 7 illustrates a section view of 180° water jacket showing the interior flow cavity with turbulators 1, baffles or channel features removed for clarity. The preferred interior has baffles and/or turbulators 1.

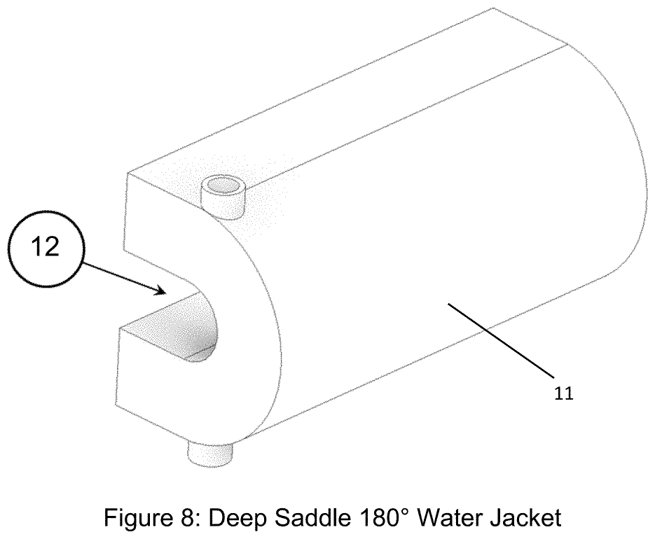

FIG. 8 illustrates a deep saddle 180° water jacket.

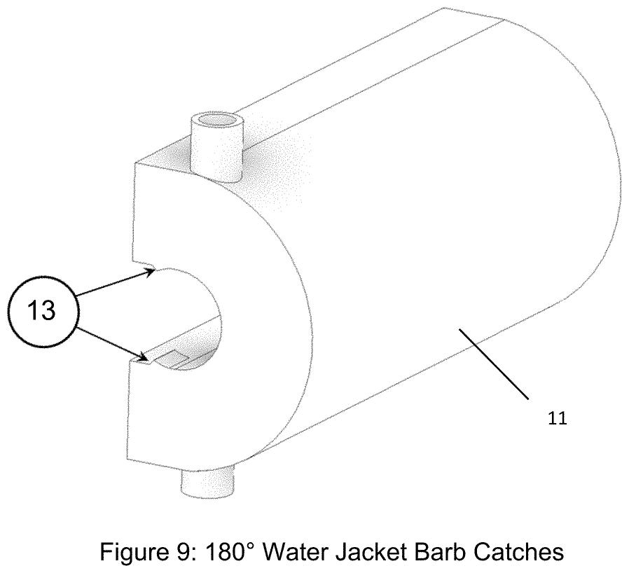

FIG. 9 illustrates a 180° water jacket with barb catches.

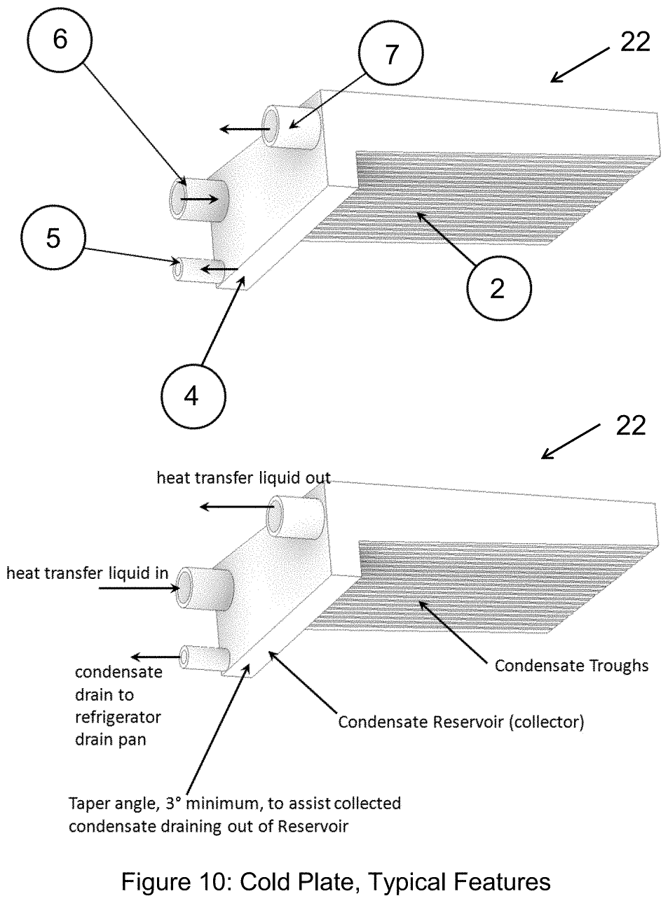

FIG. 10 illustrates a cold plate, typical features.

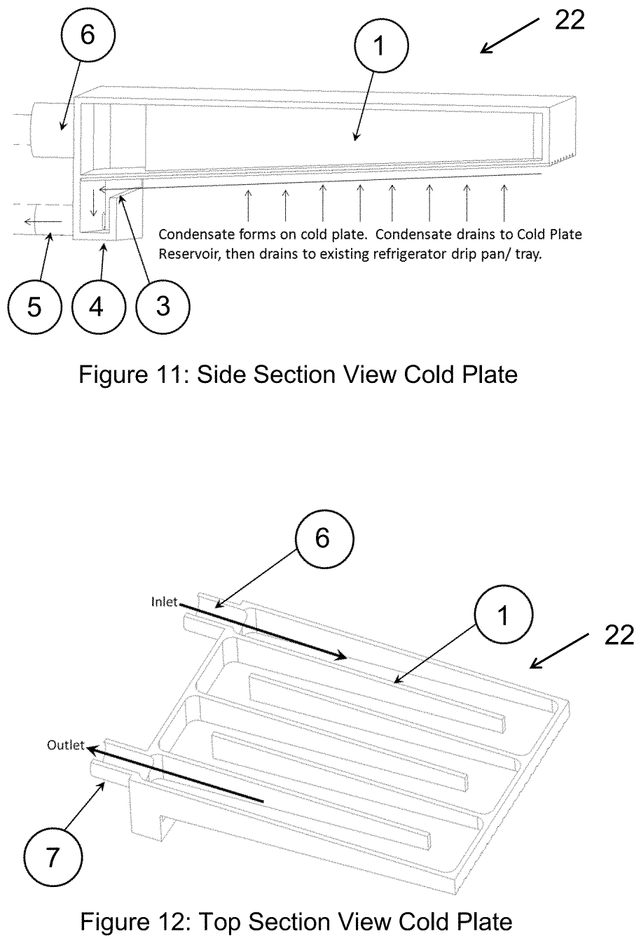

FIG. 11 illustrates a side section view cold plate.

FIG. 12 illustrates a top section view cold plate.

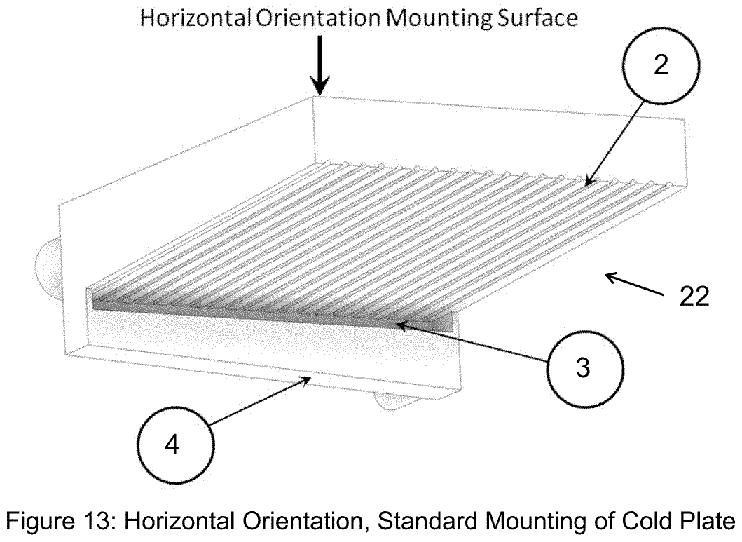

FIG. 13 illustrates a horizontal orientation, standard mounting of cold plate.

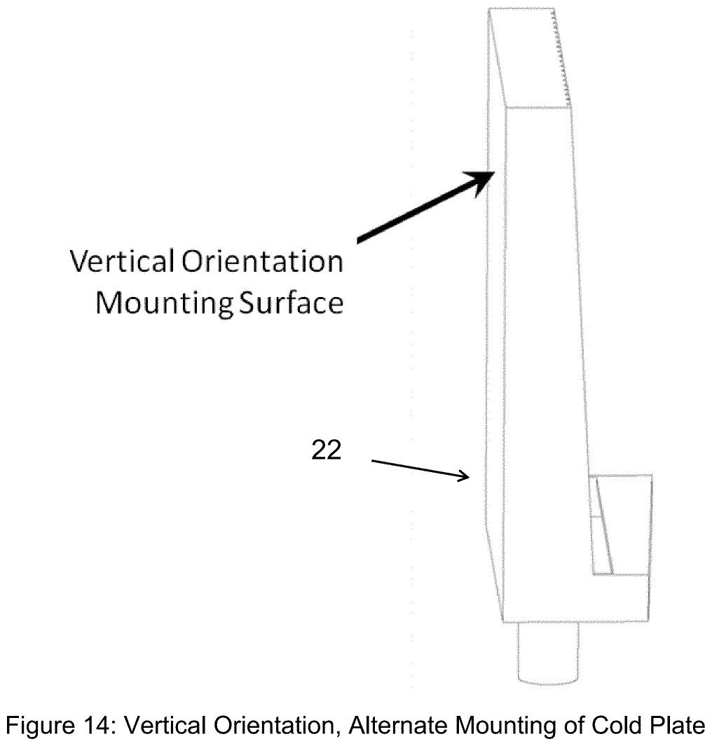

FIG. 14 illustrates a vertical orientation, alternate mounting of cold plate.

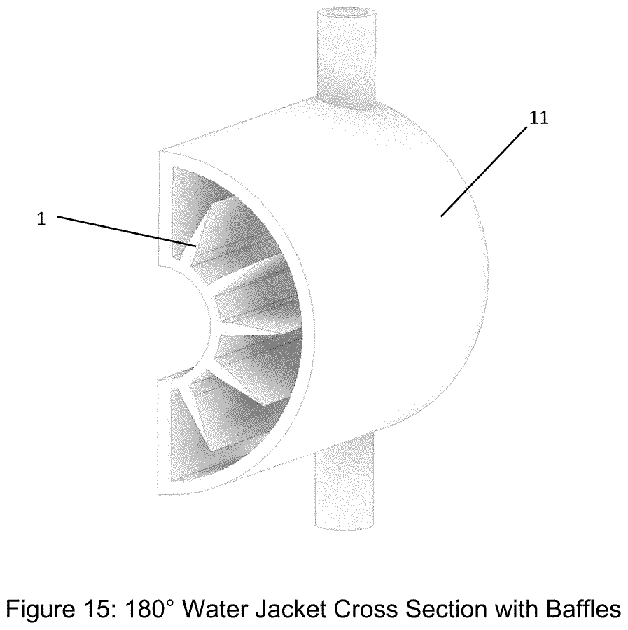

FIG. 15 illustrates a 180° water jacket section view with baffles.

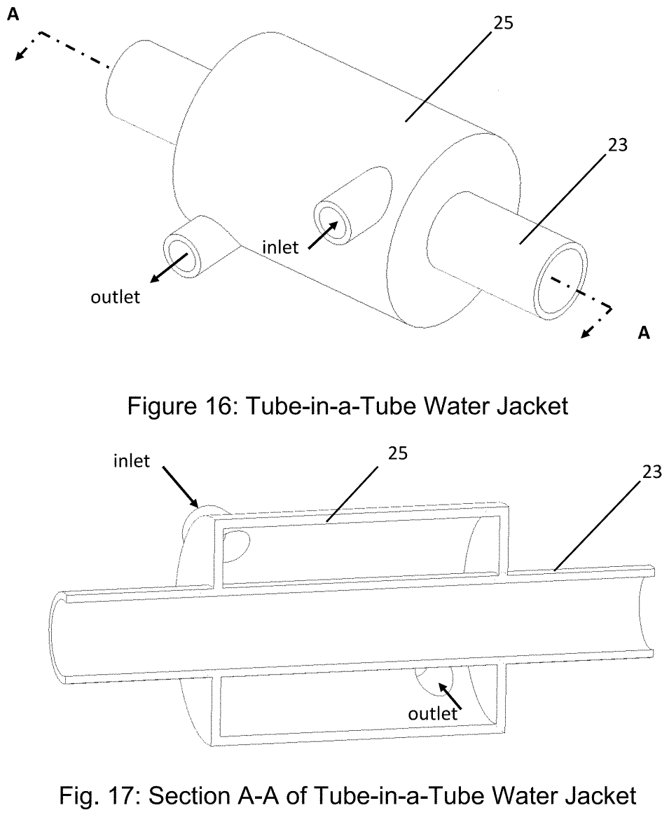

FIG. 16 illustrates a tube-in-a-tube water jacket.

FIG. 17 illustrates section A-A of FIG. 16.

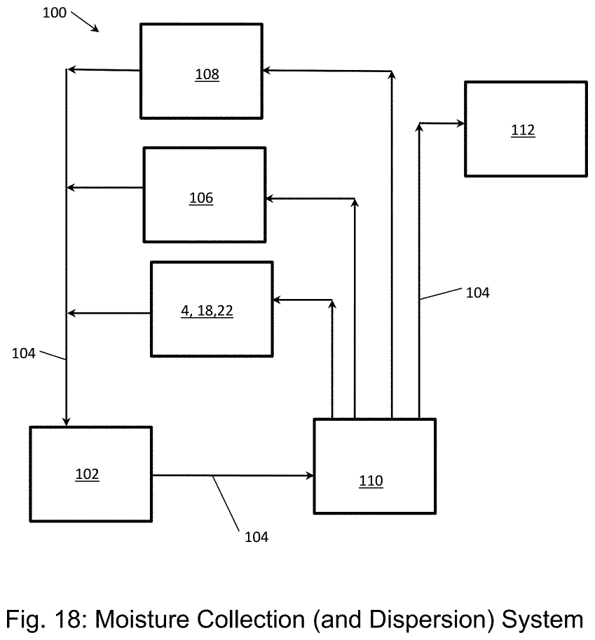

FIG. 18 illustrates a preferred embodiment of the collection system for a refrigerated space.

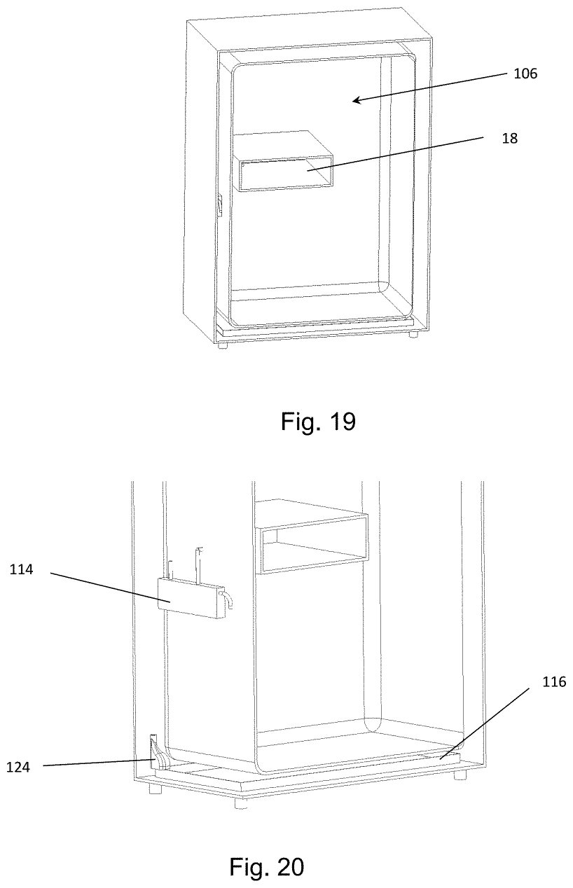

FIG. 19 illustrates a sectional view of a refrigerator having a crisper drawer.

FIG. 20 illustrates a similar view of FIG. 19 but with the outside wall of the refrigerator removed for a better view of a preferred crisper reservoir and a master drip pan.

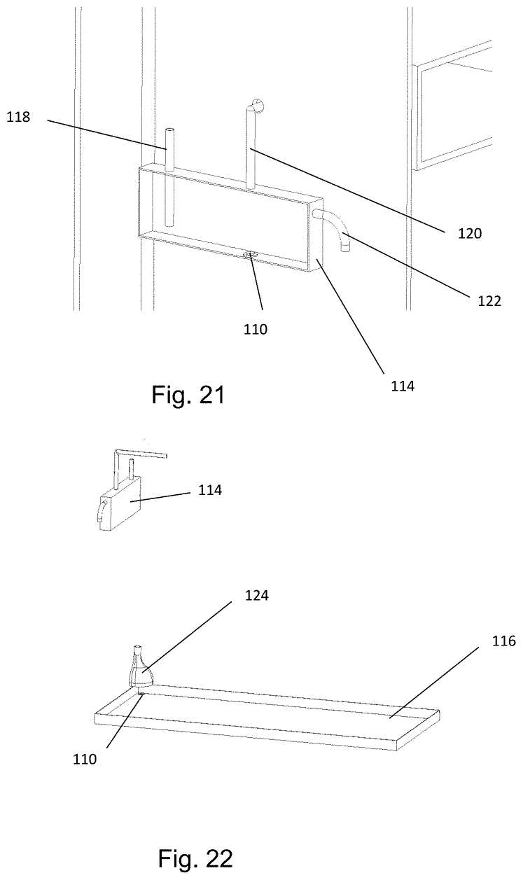

FIG. 21 illustrates a closer-up view of the crisper reservoir in FIG. 20.

FIG. 22 illustrates a master drip pan reservoir and chimney vent positioned above a humidifier/vaporizer.

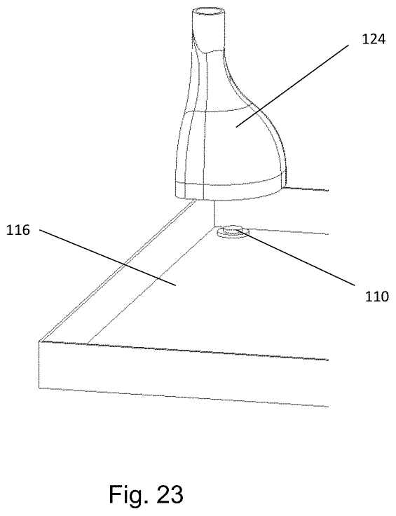

FIG. 23 illustrates a closer view of the chimney vent of FIG. 22.

### NUMBERED ELEMENTS OF INVENTION

Cold Plate Baffles/Turbulators 1 (turbulators can also be used in water jacket embodiments e.g., FIG. 15

Cold Plate Condensate Troughs 2

Cold Plate Condensate Reservoir Inlet 3

Cold Plate Condensate Reservoir 4

Cold Plate Condensate Reservoir Drain (to refrigerator drip tray) 5

Cold Plate Heat Transfer Fluid Inlet 6

Cold Plate Heat Transfer Fluid Outlet 7

180° Water Jacket (½ Water Jacket) 8

180° Water Jacket Inlet 9

180° Water Jacket Outlet 10

180° Water Jacket 11

180° Water Jacket Deeper Mounting Slot 12

180° Water Jacket Snap On Retention Barb 13

Peristaltic Pump with Motor 14

Electrical Power Wire to Pump Motor 15

Tubing 16

Existing Refrigerator Drain Pan 17

Crisper (Drawer), inside refrigerator 18

Thermally Conductive Adhesive/Epoxy 19

Deep Saddle 180° Water Jacket 20

Existing Refrigerator Drip Tray 21

Cold Plate 22

Existing Refrigerator Evaporator Return Gas Refrigerant Tube, Suction Line 23

Tube-in-a-tube water jacket 25

### DESCRIPTION OF THE PREFERRED EMBODIMENTS

This invention is embodied in a system which creates a localized temperature below the dew point temperature inside a compartment/crisper (18) of a refrigerator in order to extract condensate from the air. After this system extracts said condensation, it collects it and preferably removes it from the refrigerator's interior. Creating this localized, below-the-dew-point temperature is not to alter the temperature of the environment (e.g. the entire refrigerator) but to extract moisture from the air inside a compartment of the refrigerator (like a crisper, for example).

By way of background, a typical refrigerator has an evaporator and a condenser. The typical refrigerator evaporator turns its refrigerant into the gas state before the refrigerant travels to the refrigerator's compressor. The refrigerant (in the gas state) is cold as is exits the evaporator. (This information is meant as a partial review of the typical refrigeration cycle present in most refrigerators.)

This invention employs a refrigerator's cold evaporator return line, or suction line, by retro-fitting a 180° Water Jacket (11) onto this line. Energy transfer between the water jacket 11 and the return line chills a heat transfer fluid inside the 180° Water Jacket (11). The heat transfer liquid is in fluid communication (typically via flexible tubing) with a Cold Plate (22) inside a refrigerator's crisper (18). The Cold plate (22) is chilled via a fluid loop transferring heat from the Crisper (18) air to the refrigerator's refrigerant gas (after it has left the evaporator) via the invention's Water Jacket (11). Once chilled, the Cold Plate (22) creates a local cold feature within the crisper (18). This heat transfer will result in the introduction of a controlled localized cold feature inside the refrigerator, i.e. the Cold Plate (22).

As shown in FIGS. 3 and 4, the preferred embodiment mounts a Water Jacket (11) on the tube carrying the refrigerator's cold refrigerant gas, leaving the refrigerator's evaporator. This fluid loop connects this water jacket (11) to a Cold Plate (22). This Cold Plate (22) is the cold feature which will draw condensation out of the air inside the refrigerator. The fluid in this loop between the Water Jacket (11) and Cold Plate (22) allows for the flow of any suitable fluid, to transfer heat from the cold plate to the refrigerator's refrigerant.

This heat transfer fluid could be saltwater, Coolanol, ethylene glycol mixed with water, ethylene glycol with copper oxide and water, or any other suitable heat transfer fluid. As these lines/tubes (16) are not under any appreciable pressure, they may be constructed out of inexpensive, flexible, plastic tubing with inherent insulating properties. While the fluid flow in this service loop may occur through natural thermal induced flow, a pump is the preferred method of creating a mode of flow. A Peristaltic Pump (14) is the preferred pump for this application. A Peristaltic Pump (14) can deliver low volume and steady/consistent flow with very little power consumption. The control logic for commanding the Peristaltic Pump (14) on/off could utilize a humidity sensor inside the crisper. Alternatively the Pump (14) could switch on/off with the refrigerator's existing condenser fan (or compressor motor), using the refrigerator's existing binary or trinary switch. Ideally, the Pump (14) will be compatible with the power source used by the condenser fan or some other existing refrigerator voltage.

Extracting moisture from the air could be expedited if a Circulation Fan adjacent to the Cold Plate (22) directed air across the cold plate's surface(s), though the preferred embodiment is without a fan. The preferred orientation of the Cold Plate (22) is horizontal, see FIG. 13. The horizontal orientation maximizes the exposed cold surface facing the food items below it. Specific Crisper (18) geometry may dictate a vertical Cold Plate (22) installation, see FIG. 14.

The preferred surface of the Cold Plate (22) exposed to the food has Troughs (2), sloped towards the Cold Plate Condensate Reservoir (4), see FIGS. 3, 10 & 11. This Cold Plate Condensate Reservoir (4) stores condensate runoff from the Troughs (2) momentarily, before the collected condensate is gravity fed to the refrigerator's much larger Drip Tray/Drain Pan (17) via the Cold Plate Condensate Reservoir Drain (5).

The minimum recommended slope angle for the Condensate Troughs (2) is 3 degrees. The floor of the Cold Plate Condensate Reservoir (4), should similarly have a minimum 3 degree slope to facilitate draining of the collected condensate.

Moisture extracted from the air, by the Cold Plate (22) (below the dew point temperature) should be removed from the Cold Plate (22). This condensate may be directed to the refrigerator's existing Drip Tray/Drain Pan (17) and/or plumbed to an external facility/building drain.

Alternatively, a collection system 100 could be utilized. As shown in FIG. 18, the collection system 100 preferably comprises a collection reservoir 102 and conduits 104. The collection reservoir could be the Cold Plate Condensate Reservoir (4) mentioned previously or it could be a separate reservoir. This collection reservoir 102 could accept moisture from the Cold Plate (22). In addition, moisture collected in other areas could also be directed into the collection reservoir 102. For example, moisture from other parts of the refrigerated space 106 could be directed to the collection reservoir 102. Or, the moisture from a freezer 108 (e.g, during a defrost mode) could be directed to the collection reservoir 102. In this way, moisture from other areas (Cold Plate (4, 22), refrigerated space 106, or freezer 108) would travel via conduits, preferably by flexible tubing, to one or more collection reservoirs 102. Alternatively, any of these condensate collectors (Cold Plate Condensate Reservoir 4 or collection reservoir 102) may be drained by the user manually. A buoyant level switch could further alert the user of the condensate collector's full/empty status.

Returning Moisture to the Refrigerated Space (or Outside the Refrigerated Space)

In order to maintain a moisture balance within the refrigerated space 106, a humidifying device 110 could be added to the collection system 100, making it a collection and dispersion system. The humidifier 110 could be used to add moisture back into the ambient air of the refrigerated space 106 in the form of water vapor. For example, a piezoelectric or sonic atomizer could be positioned near (or in) the collection reservoir 102 in order to use the condensate liquid as a source for adding (reintroducing) water vapor back into the ambient air of the refrigerated space 106, or the crisper drawer 18, or the freezer space 108. This humidifying device 110 could be used intermittently as needed to keep the moisture level in these spaces at the desired level. Alternatively, the humidifier could be directed to disperse the moisture outside the refrigerated space 112.

FIGS. 19-23 illustrate a preferred embodiment of a collection and dispersion system 100. FIG. 19 illustrates a refrigerator having a refrigerated space 106 and a crisper drawer 18. FIG. 20 illustrates two collection reservoirs 102: a crisper drawer collection reservoir 114 and a master drip tray reservoir 116. FIG. 21 illustrates a closer up view of the preferred crisper drawer collection reservoir 114. The crisper drawer collection reservoir 114 can have inlet tubing 118 for directing moisture from the cold plate into the crisper drawer collection reservoir 114. It can also have outlet tubing 120 for reintroducing moisture back into the crisper drawer 18. Optionally, there can also be an overspill tube 122 for directing moisture to the master drip tray reservoir 116. A humidifying device 110 (e.g., a vaporizer) such as a piezoelectric sonic vaporizer, is preferably placed underneath the outlet tubing 120.

FIGS. 22-23 illustrate an embodiment of a master drip pan reservoir 116. The master drip pan reservoir 116 can serve as a collection point for condensation forming on and collected from the evaporator coils, cold plate and water melted during freezer-auto-defrost cycle. A chimney vent 124 can be placed over a humidifying device 110. The chimney vent 124 can be plumbed to the condenser fan to blow over the condenser coil to help cool the condenser coils/refrigerant and/or it could be plumbed to disperse outside of the refrigerator into the ambient room air.

Optionally, the crisper drawer collection reservoir 114 could be eliminated and all moisture could be directed to the master drip pan reservoir 116. And those in the art will recognize other permutations. It is preferred, however to utilize two collection reservoirs 102, 116, with two piezoelectric (sonic) vaporizers 110, one for humidity management of the crisper drawer 18, and the other one for draining the master drip pan reservoir 116 into the air (as vapor) outside the refrigerator.

The 180° Water Jacket (11) is shown as a half cylinder so it may be installed and maintained without disrupting the pressurized and sealed refrigerant line exiting the evaporator. A more traditional water jacket resembles a tube-in-a-tube would be more disruptive to maintain/install. (See element 25 of FIGS. 16, 17, for example). This 180° Water Jacket (11) can be secured to the refrigerator's Evaporator Return Tube (23) with Thermally Conductive Adhesive/Epoxy (19. Alternatively, a hose clamp or saddle clamp will also allow for easy a quick installation of the Water Jacket (11). See FIG. 9 for an example of Retention Barbs (13) which can be incorporated into the Water Jacket, allowing for the Water Jacket (11) to snap into place. Regardless of the shape of the water jacket, the water jackets can comprise turbulators 1, such as the ones shown in FIG. 15, if desired.

While not as preferred, a tube-in-a-tube style water jacket 25 would also work. As shown in FIGS. 16, 17, the tube-in-a-tube style water jacket 25 completely encloses a section of the evaporator return tube 23. The reason it is not as preferred is that is that it is harder to retrofit to an existing system with a tube-in-a-tube jacket. The 180° snap-on version, on the other hand, can be added without having to disconnect, cut or replace the evaporator return tube 23. Nonetheless, the tube-in-a-tube style water jacket 25 is suitable for this invention.

The surface are of the cold plate (this is the surface area with the troughs) facing the food compartment should be approximately 15% of the total footprint (floor space), of the food compartment, or crisper) being controlled.

The surface area of the Water Jacket in contact with the refrigerator's Refrigerant Tube (exiting the evaporator) (23) should be approximately half the surface area of the cold plate facing the food compartment. This ratio may vary depending on the flow rate of the heat transfer fluid. The flow rate of the heat transfer fluid should be set as low as possible to achieve a temperature just below the dew point temperature, (as the touch temperature) of the Cold Plate (22). The formation of condensation is an exothermic process. This heat, created by the formation of condensation, will offset some of the cold introduced into the crisper by the cold plate (22) and the heat transfer fluid.

The heat transfer fluid (Coolanol, saltwater, ethylene glycol with water, propylene glycol with water, etc) flow should be sufficient to maintain a touch temperature at the Cold Plate (22) above the freezing temperature of water. This will ensure the condensate forming on the Cold Plate (22) does not freeze, which would preclude draining of condensate. This will ensure the device is maintained at a temperature below the dew point temperature in the Crisper (18). The heat transfer fluid will always be selected to have a freezing temperature below the freezing temperature of water as a precaution, to eliminate the possibility of the heat transfer fluid freezing.

Refrigerated Vehicles and Other Refrigerated Spaces

This invention works in any refrigerated space that employs a cold element. As described above the cold element can be used to create localized cooling within the refrigerated space. Typically, the most convenient cold element will be the refrigerant's line as it exits the evaporator. But as long as the element is colder than the ambient air of the refrigerated space, this invention will work. Creating a localized cold spot will force condensation to occur at that spot, which will make the overall refrigerated space drier. For example, this invention will work for refrigerated transportation vehicles, including trucks, boats, trains, and planes. All that is needed is to connect a water jacket (or its equivalent) to the cold refrigerant line and use it to cool a cold plate (or equivalent) inside the refrigerated space as described more completely above.

1. A system for removing moisture from the air inside a refrigerated space, the refrigerated space being cooled by a refrigerator having a refrigerant line and a drip pan, the system comprising,
a water jacket in thermal communication with the refrigerant line,
a cold plate, the cold plate in fluid communication with the water jacket,
a pump to circulate fluid between the water jacket and the cold plate, and a drain line, the drain line creating in fluid communication between the cold plate and the drip pan.

2. The system of claim 1, the water jacket comprising the shape of a hollow cylinder.

3. The system of claim 2, the water jacket comprising an inside diameter no bigger than an outside diameter of the refrigerant line.

4. The system of claim 1, the water jacket comprising the shape of a hollow cylinder, the hollow cylinder having a circular end face and the hollow cylinder truncated longitudinally though a chord of the end face to expose an inner diameter, wherein the inner diameter can be fitted against the outside diameter of the refrigerant line.

5. The system of claim 4, the inside diameter no bigger than an outside diameter of the refrigerant line.

6. The system of claim 1 further comprising a moisture collection apparatus and a humidifier, wherein the moisture collection apparatus collects moisture that has condensed on the cold plate and the humidifier reintroduces some of the collected moisture back to the refrigerated space in vapor form.

7. The system of claim 6 wherein the humidifier directs water vapor into a frozen space, a crisper drawer, or to a space outside of the refrigerated space.

8. The system of claim 6, the moisture collection apparatus comprising a collection reservoir.

9. The system of claim 7, the humidifier in fluid communication with the collection reservoir.

10. A moisture collection system for a refrigerated space, the collection system comprising,
a collection reservoir, a humidifier, and a conduit system,
the conduit system directing condensation from the refrigerated space into the collection reservoir,
the humidifier using moisture collected by the reservoir to direct water vapor into one or more of the group consisting of a crisper drawer, the refrigerated space and a space outside of the refrigerated space.

11. The moisture collection system of claim 10 further comprising a frozen space, the conduit system directing condensation from the frozen space into the collection reservoir.

12. The moisture collection system of claim 10 further comprising a second collection reservoir.

13. The moisture collection system of claim 11 further comprising a second humidifier.

14. The moisture collection system of claim 12 wherein moisture collected in the second collection reservoir is directed into a crisper drawer via tubing.
